(19) United States
(12) Patent Application Publication
(10) Pub. No.: US 2002/0133269 A1
(43) Pub. Date: Sep. 19, 2002

(54) Product vending machines and software therefor

(76) Inventor: Alejandro Federico Gonzalez Anselmi, (US)

Correspondence Address: Curtis, Mallet-Prevost, Colt & Mosle LLP, 101 Park Avenue, New York, NY, 10178-0061, US

(21) Appl. No.: 09/784,504

(22) Filed: Feb. 15, 2001

(30) Foreign Application Priority Data
Feb. 16, 2000 (UY) 26.014

(51) Int. Cl. G07F 7/08

(52) U.S. Cl. 700/231

(57) ABSTRACT

An improvement in product vending machines and software for the operation thereof is provided to enable payment by credit or debit card instead of bills, coins, tokens or prepayment cards.

The present patent application refers to improvements in product vending machines in general, and more particularly of vending machines for newspapers and magazines.

The improvements refers to the payment for the product which is done with a credit or debit card instead of using prepayment card, bills, coins or tokens as is the means known up to now. Software is used to process the credit or debit card payment to enable the function of the vending machine.

In every vending machine for products such as newspapers, food, drinks, candy, etc, the functioning process requires payment before dispensing the products. This payment is known to be done by prepayment cards, tokens, bills or coins. These means present different types of disadvantages. The tokens as well as the prepayment card have to be bought beforehand, and bills and coins offer other problems such as the lack of the required denominations or failure of the machine to accept the bills or coins. An additional disadvantage related to the token is the wrong, but often shown, attitude of trying to fool the vending machine by inserting a similar object which causes damage to the vending machine.

The means proposed for payment are known credit or debit cards, which enable an exceptional smoothness in functioning due to the elimination of all electromechanical devices such as required by bill, coin and token receptors.

The proposal includes in the machine an external credit card reader, an internal processor for control and an interface which, using devices and known means, enables communication between the different elements of command of the machine, such as switch, the disablement state of the machine, through the different electrical signals and the processor for control.

This allows to send operating signals for the different mechanical parts of the machine through the processor for control by means of external commands.

In addition to what has been disclosed, the software designed for the referred control is also included, which is part of the invention herein whose protection is required.

This software enables the achievement of two complementary goals. Firstly, the registration and capacity of the user who takes a product from the machine, being the debits corresponding to such user then charged are stored in electronic or printed form, for transmission (by physical or electronic means) to the issuing entity of the credit card used. Secondly, the software also allows the vending machine owner/operator to change the price of the products, include new products, etc, as well as to read and print (without discarding electronic registration) all the operations done such as dates, hours, sold products, etc.

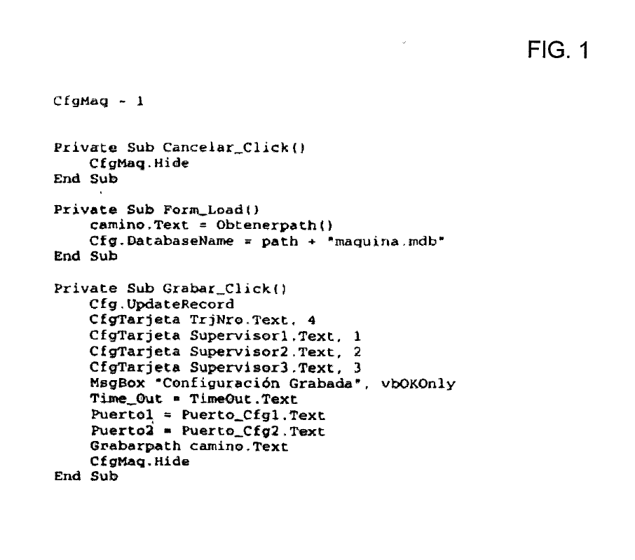

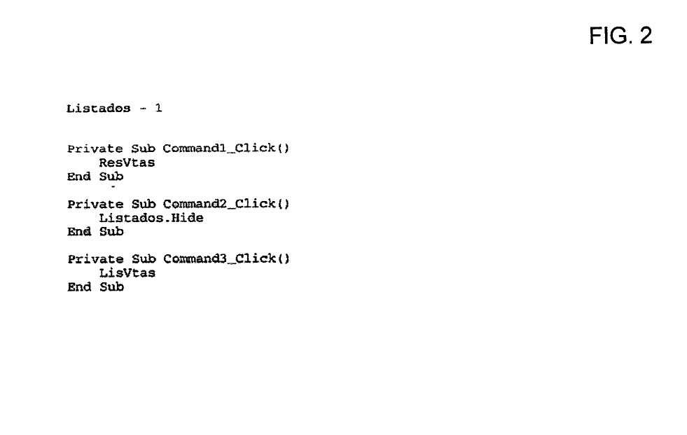

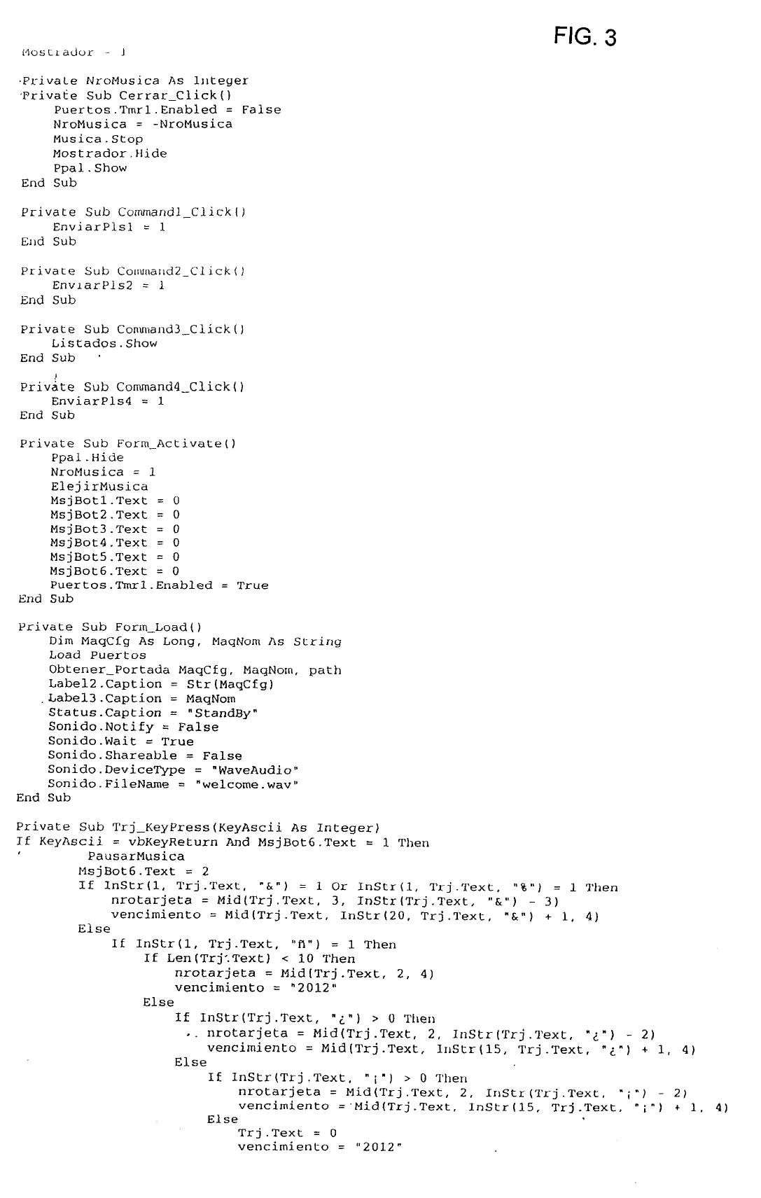

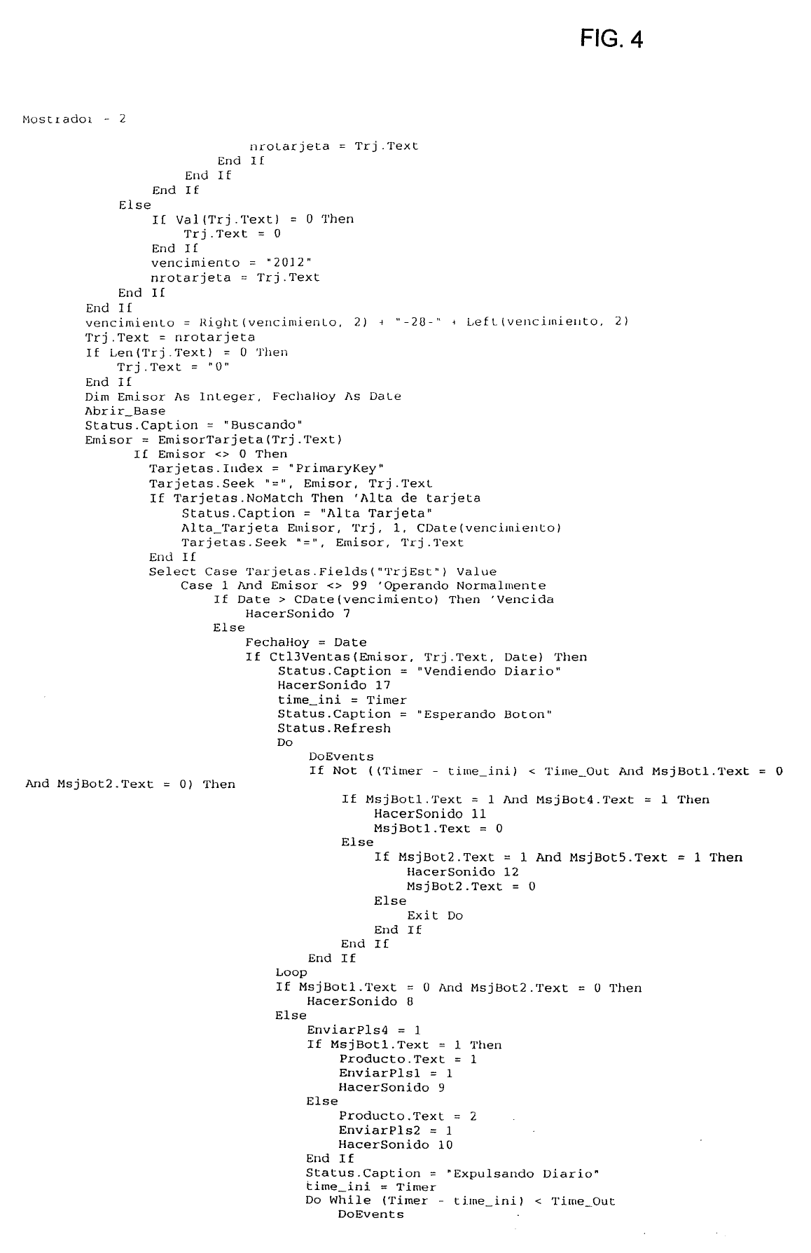

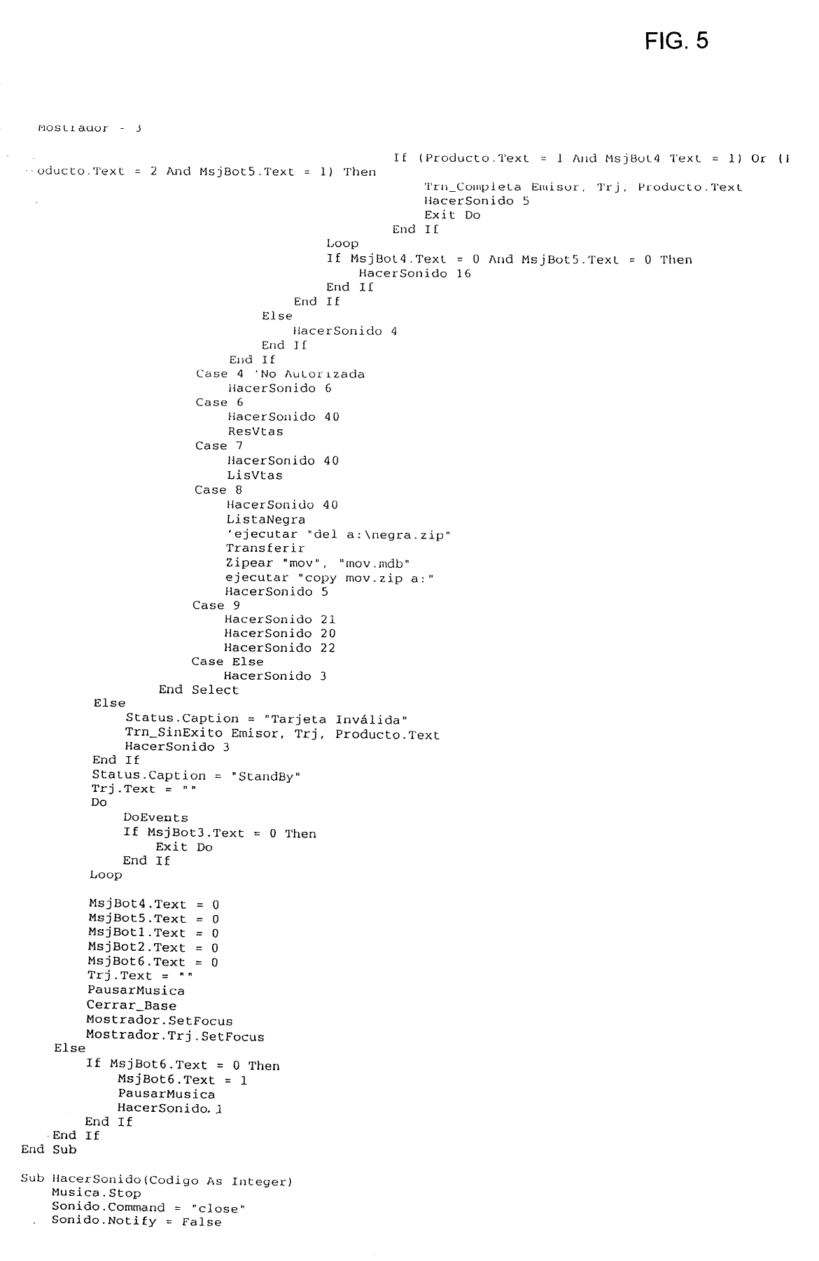

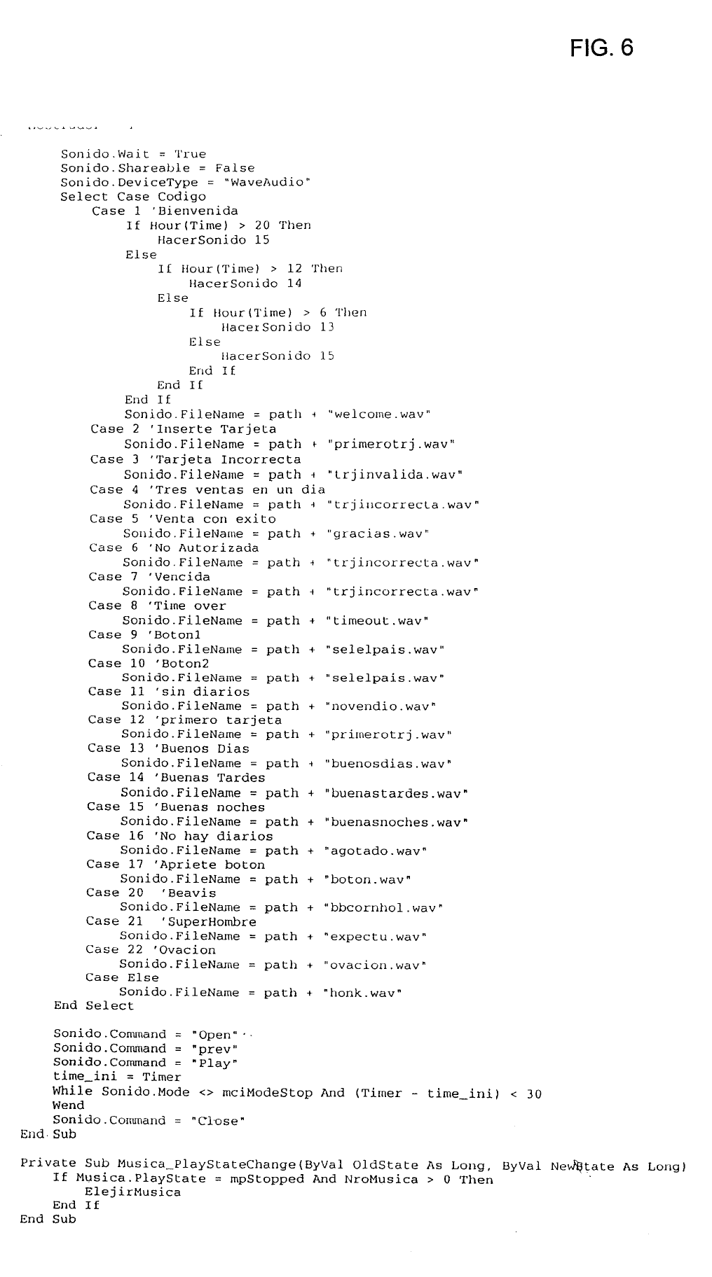

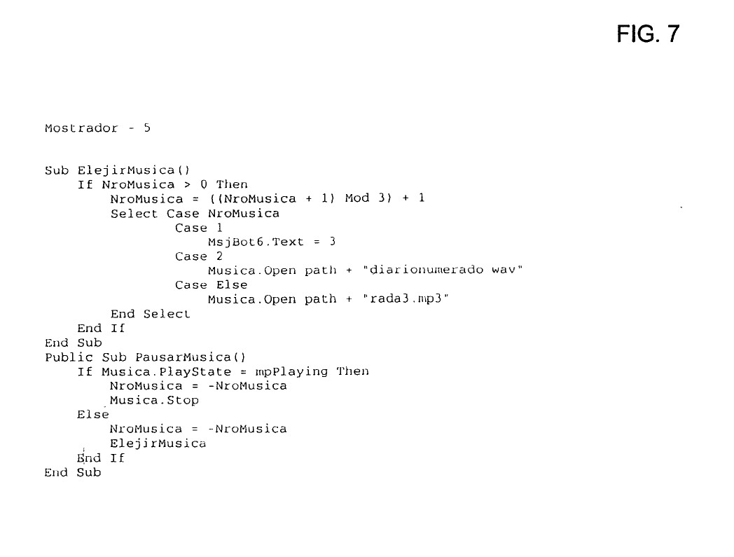

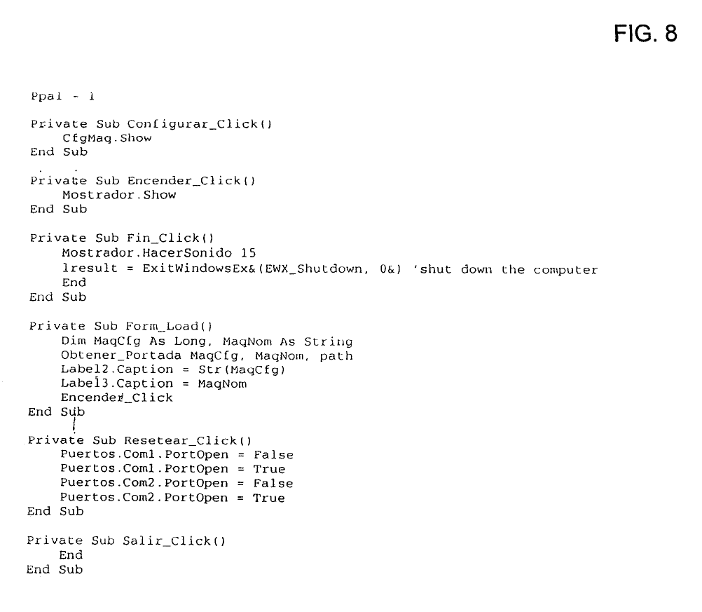

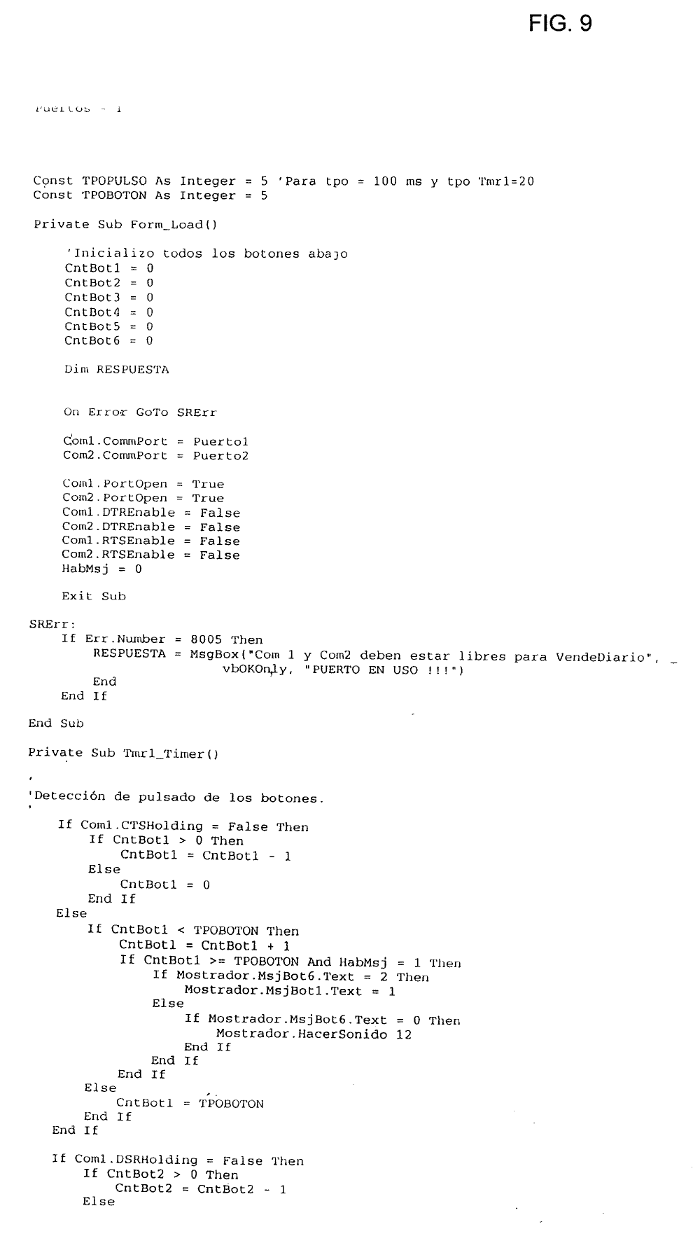

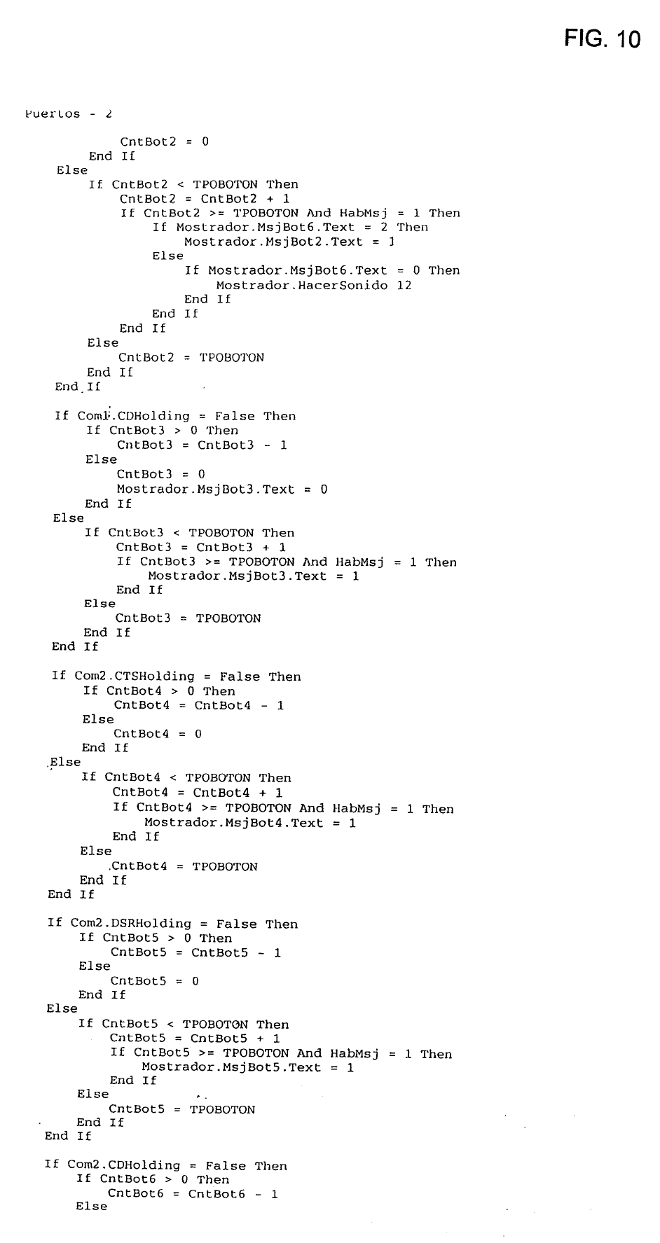

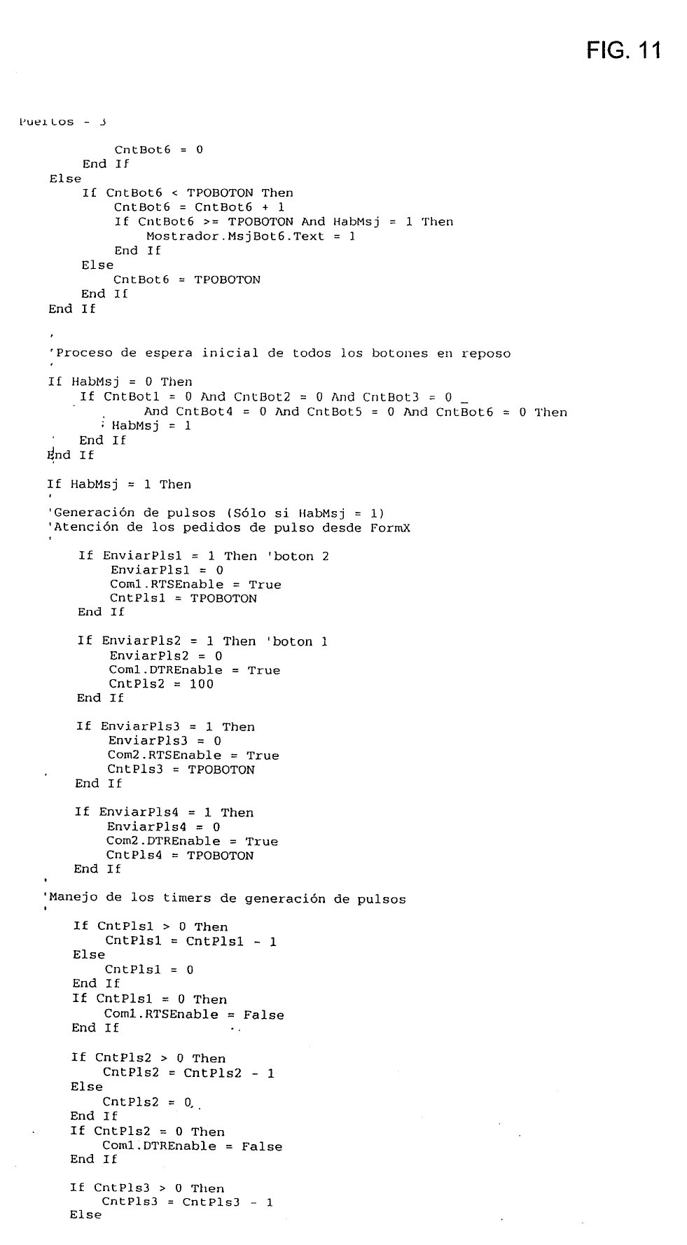

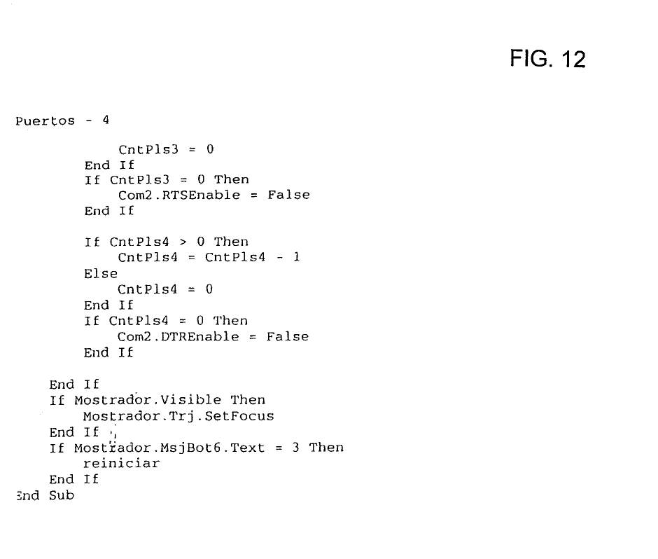

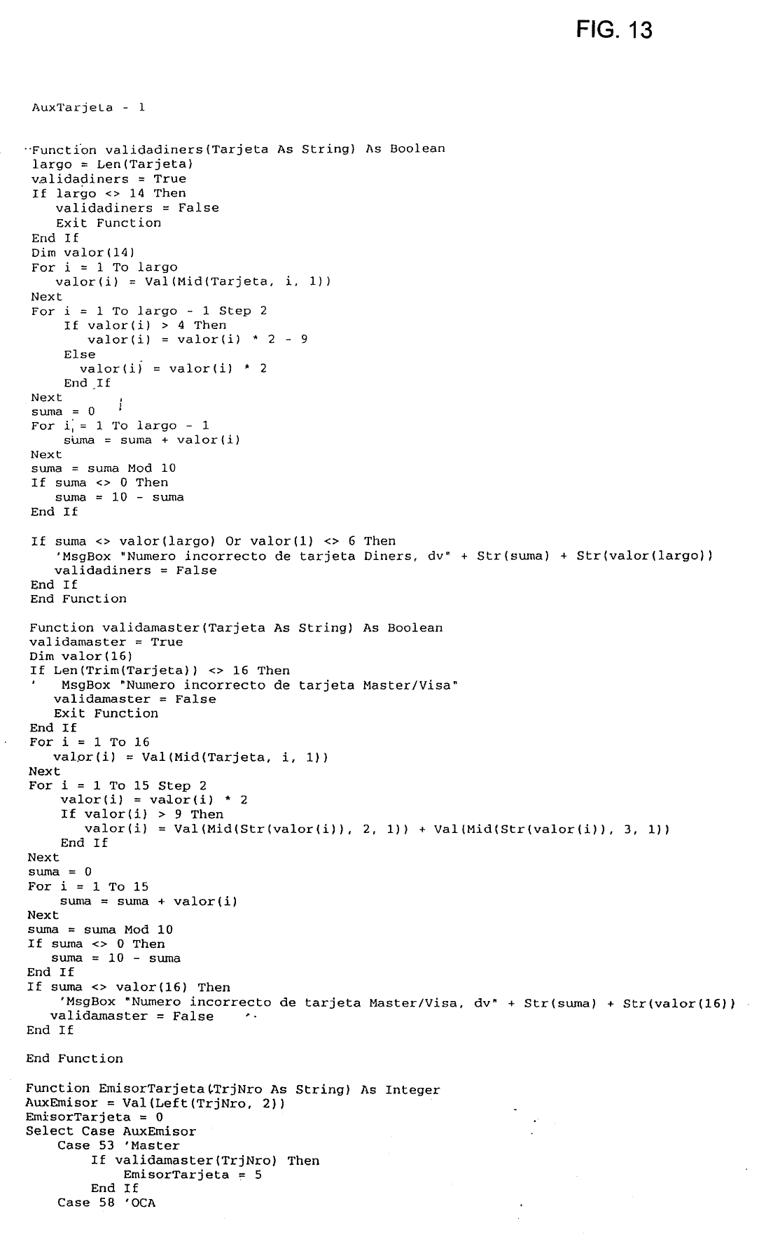

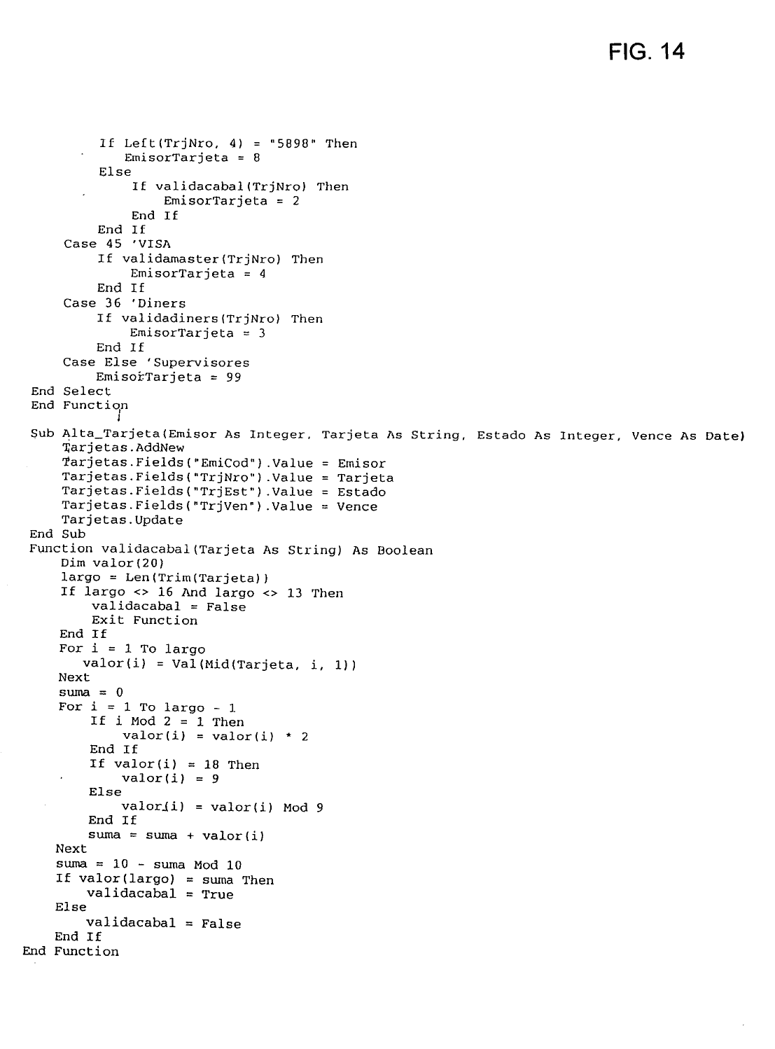

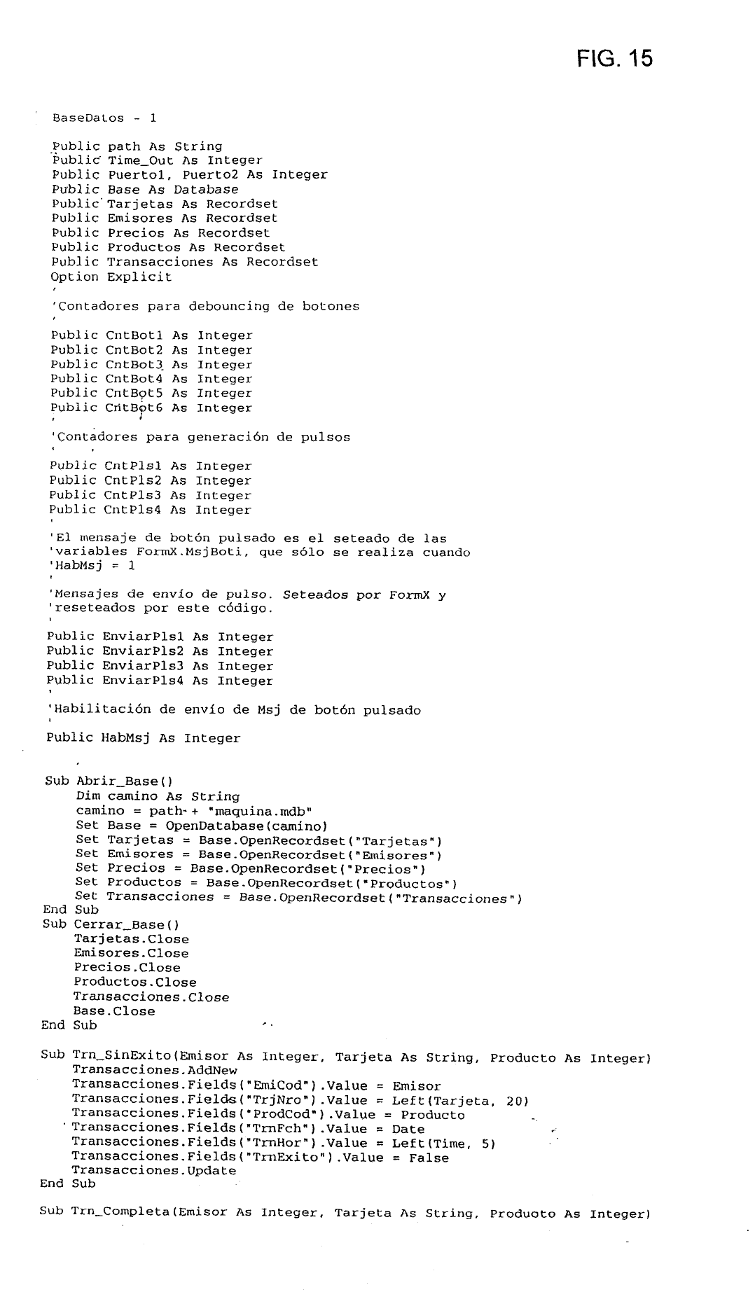

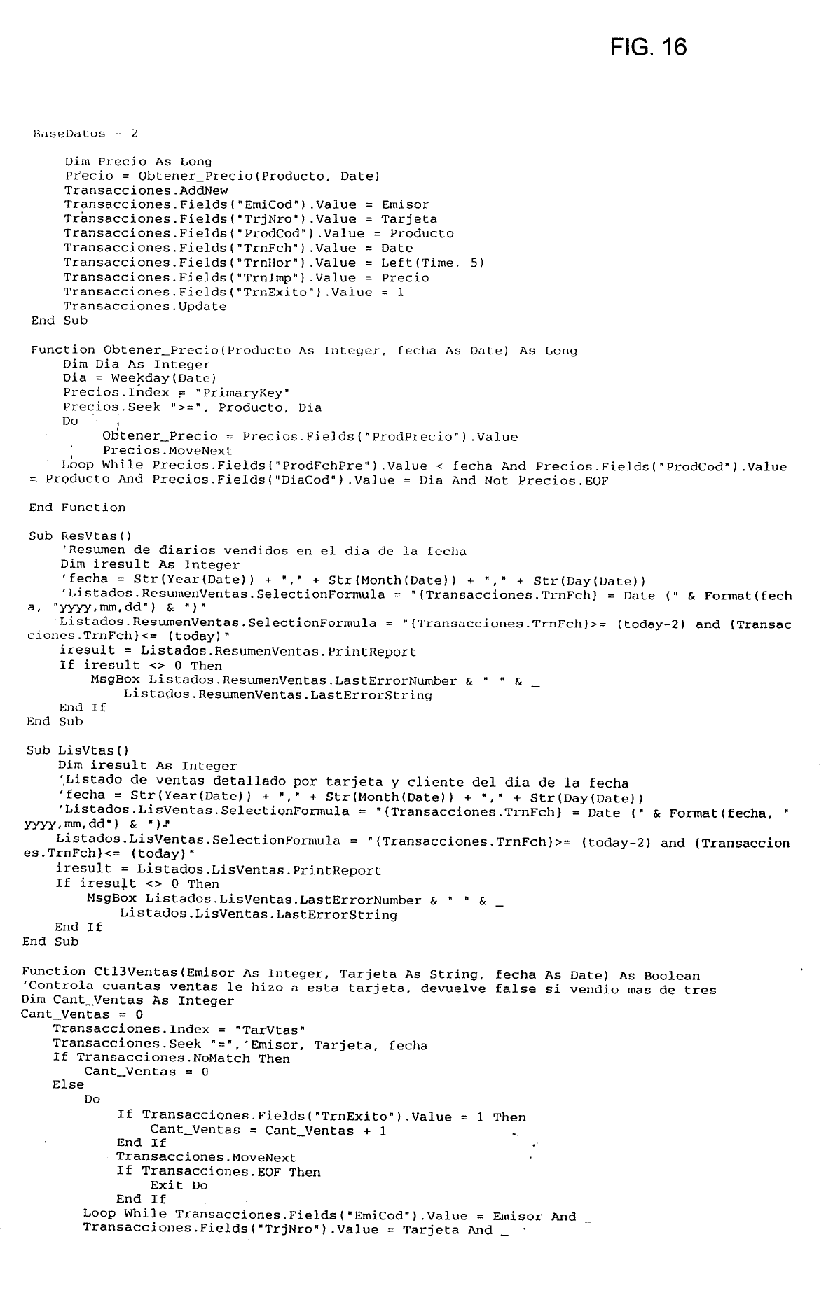

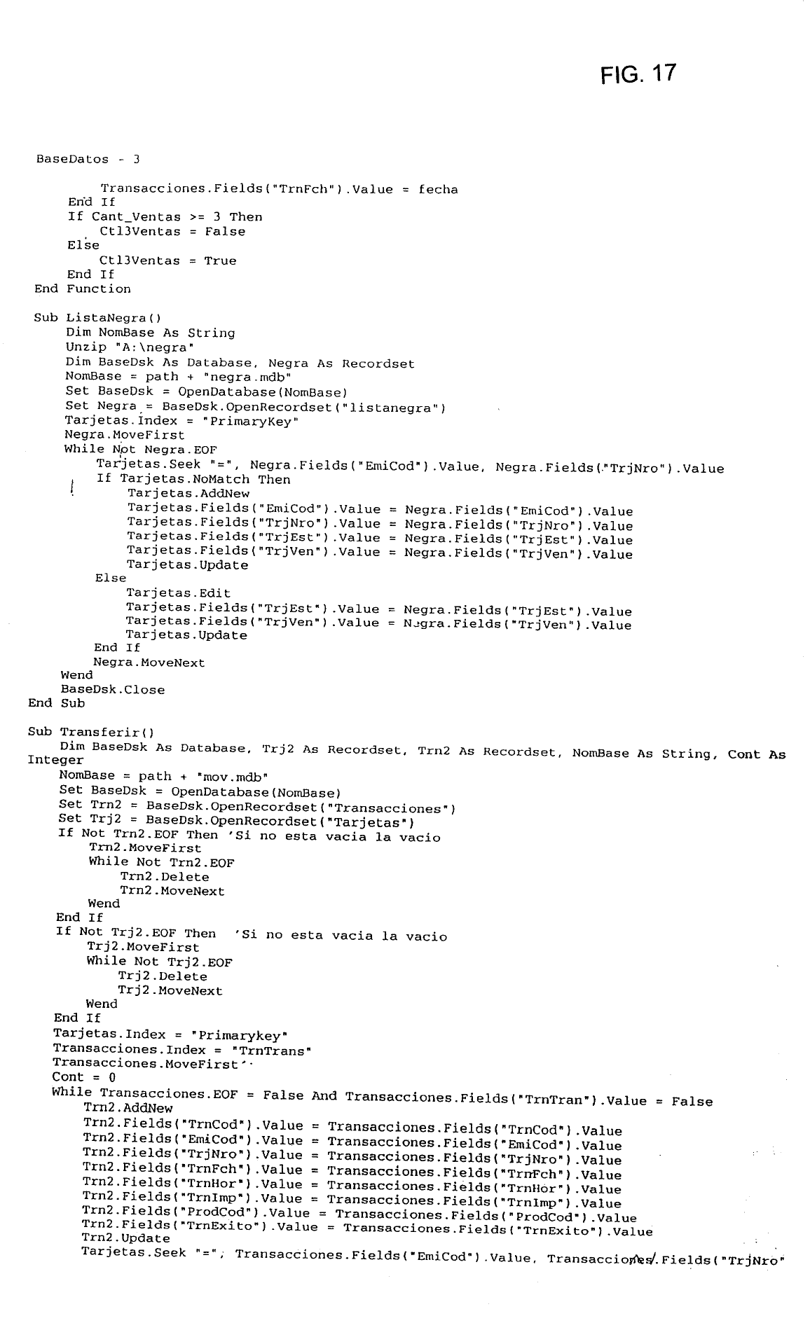

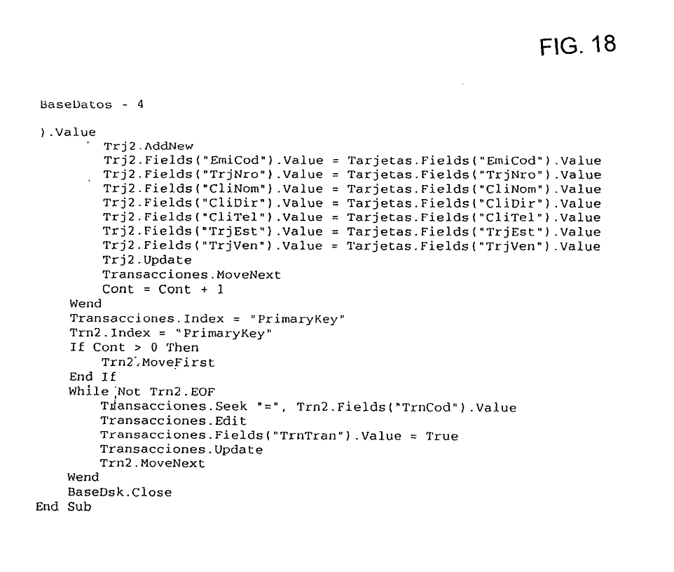

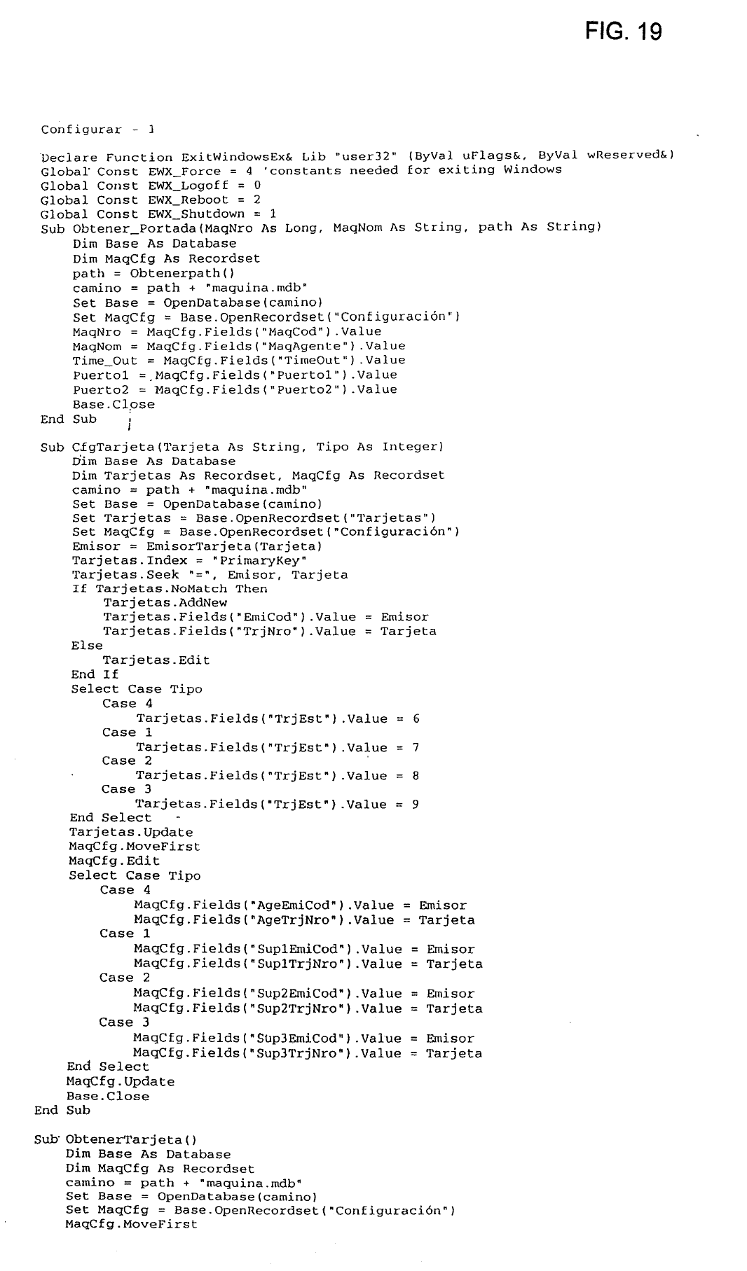

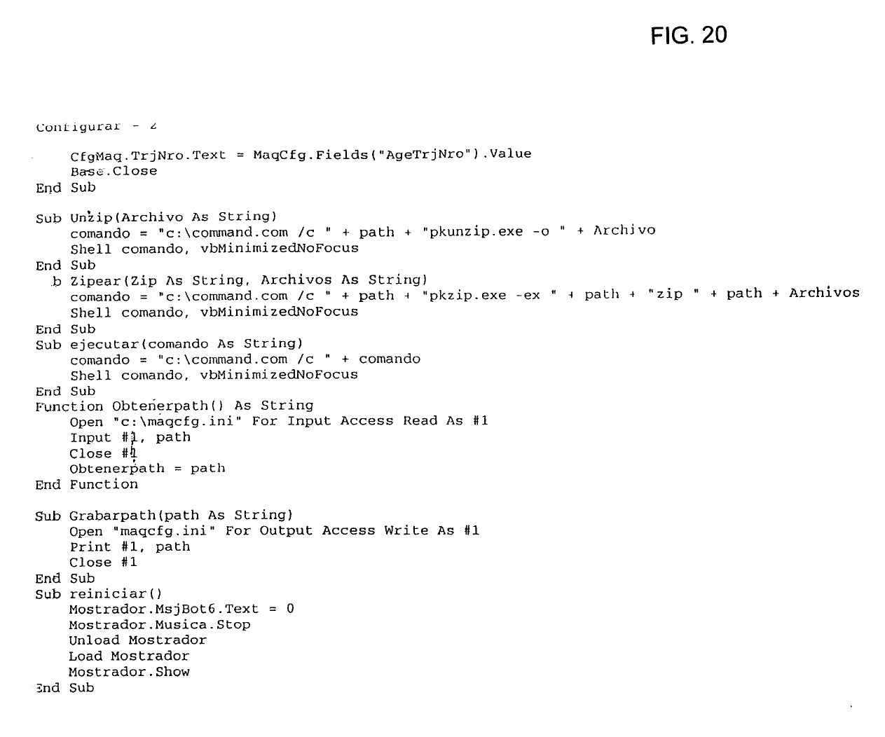

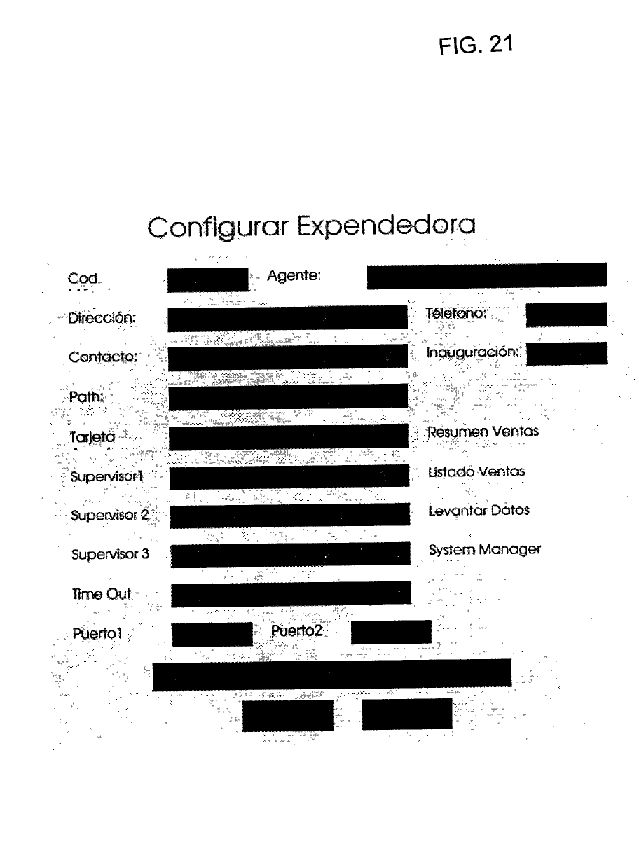

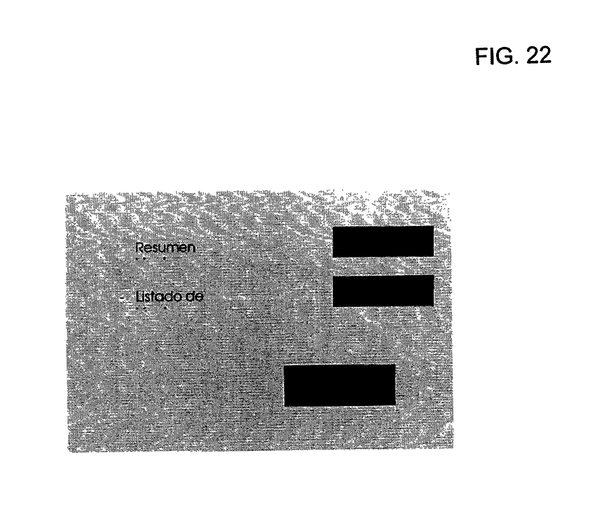

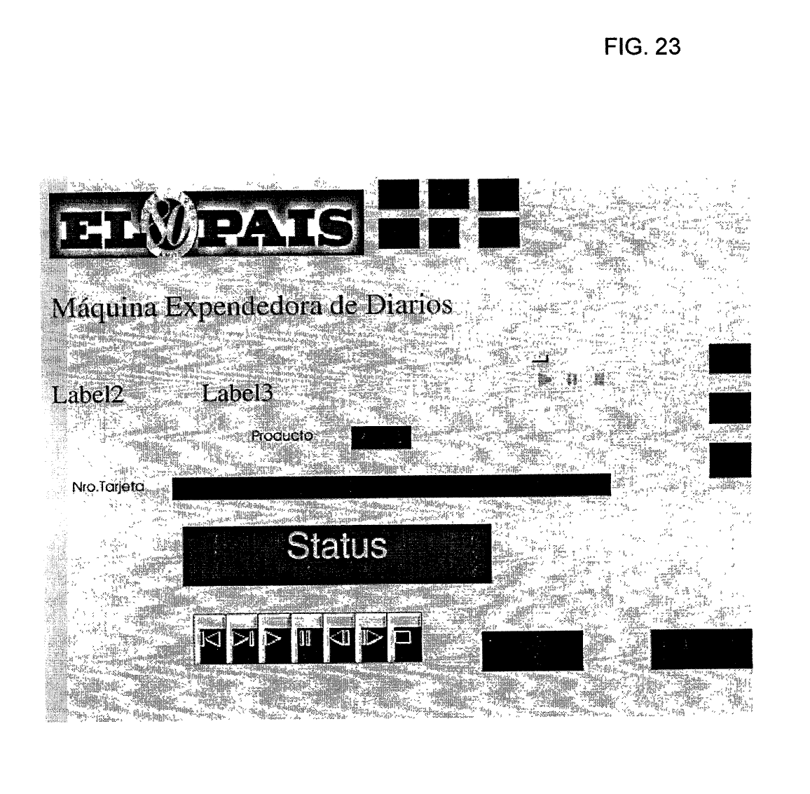

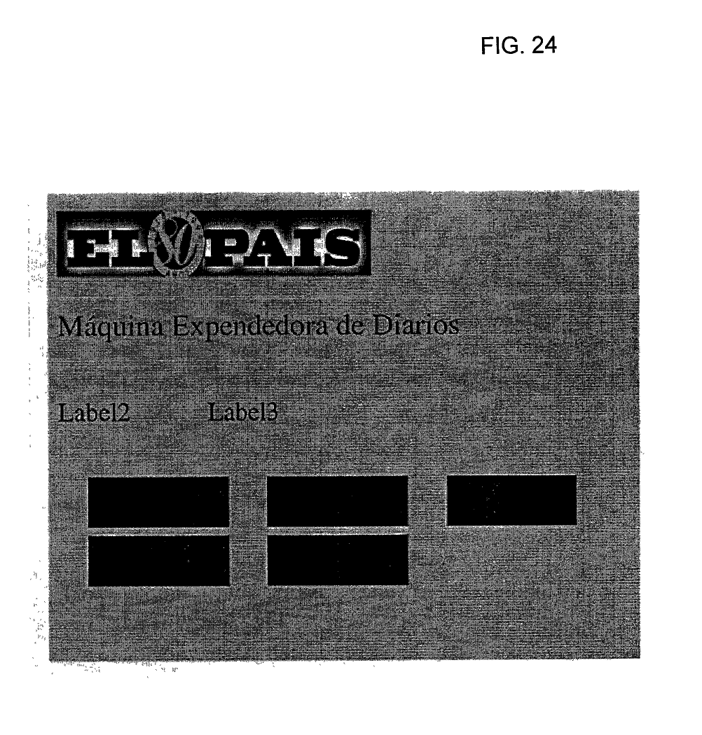

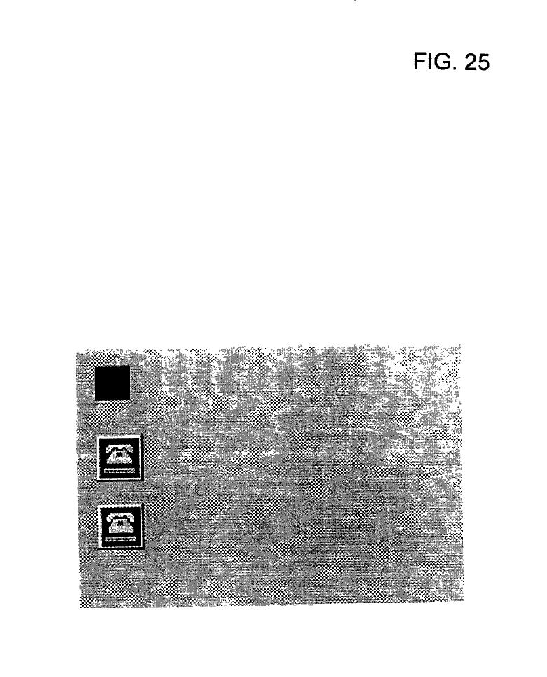

The source code for the software is listed in the attached FIGS. 1-20. FIGS. 21-25 show the output screens as displayed during the operation of the software.

While certain novel features of this invention have been shown and described, it will be understood that various omissions, substitutions and changes in the forms and details of the device illustrated and in its operation can be made by those skilled in the art without departing from the spirit of the invention.

1. Improvements in vending machines for products such as newspapers, different types of foods and drinks, candy, etc., the improvement characterized by the payment for the products being done using a credit card, instead of prepayment card, coins or tokens which are the usual means used until now, applying a new combination of known elements and computer software of application for the management, control and registration of the different operations of the machine.

2. The improvements in vending machines for products according to claim 1, characterized in that the improvements include an external credit/debit card reader, an internal processor for control and an interface which, using devices and known means, enables communication between different elements of command of the vending machine, such as a switch and a disablement state of the vending machine, through the use of different electrical signals and the processor for control.

3. The improvements in vending machines for products according to claim 2, characterized because by means of the components identified in claim 2 it is possible, through the processor for control and the software, using external commands, to send operating signals to different mechanical parts of the machine as well as to register the capacity of the user who purchases a product from the vending machine, where the debits corresponding to such user then charged in a diskette or a printed list, for sending it (by physical or electronic means) to the issuing entity of the credit or debit card used,
further characterized in that such computer software allows an operator to change the price of the products, include new products, and other functions, as well as to read and print (without discarding electronic registration) all the operations done such as dates, hours, and number of products sold.

4. The improvements in vending machines for products according to claim 1, characterized because the software or application referred in the previous claims is as identified in FIGS. 1-20.

5. A vending machine for products including the improvements detailed in the claim 4.
